(19) United States
(12) Patent Application Publication
(10) Pub. No.: US 2014/0195385 A1
(43) Pub. Date: Jul. 10, 2014

(54) APPARATUS AND A METHOD FOR SIMPLYING AND DISPLAYING INFORMATION

(71) Applicants: Er-Yi Toh, Singapore (SG); Hsuan Lei Foo, Singapore (SG)

(72) Inventors: Er-Yi Toh, Singapore (SG); Hsuan Lei Foo, Singapore (SG)

(21) Appl. No.: 14/241,562

(22) PCT Filed: Aug. 31, 2012
(86) PCT No.: PCT/SG2012/000312

§ 371 Date: Feb. 27, 2014

(30) Foreign Application Priority Data
Sep. 1, 2011 (SG) 201106382-3

(51) Int. Cl. G06Q 30/06

(52) U.S. Cl. CPC G06Q 30/0625
USPC 705/26.62

(57) ABSTRACT

A method of generating a presentation comprising providing a collection of content where each unit of content has an identifier, providing a seed unit of content that contains references to the said identifiers, searching the existing collection of content for units of content with identifiers that are referenced by the seed unit of content, generating a presentation by gathering all units of content that were found in the said searching, whereby the presentation generated can contain more content than the seed content. Also a method of placing an order comprising providing an item with a plurality of pricing tiers, providing pricing rules for enforcing the said pricing tiers, providing a criterion, providing a method to identify inputs required from the user such that an order can be created that meets the requirements of the user while optimizing said criterion while conforming to the said pricing rules, requesting the said identified inputs from the user of the client system, whereby the user of the client system is not exposed to the pricing tiers and is not able to submit an order that violates the pricing rules. Also an apparatus.

### TECHNICAL FIELD

The present invention relates to e-commerce sites and, more particularly, to an apparatus and method for simplifying the process of publishing pricing and multimedia information for goods or services such as travel-related products.

### BACKGROUND OF THE INVENTION

The e-commerce sites found on the internet enable customers to select and make payments online for a product or service. Typically, a customer would browse through various multimedia content (e.g. text, photos, videos, and the like) which represent the goods or services offered by the site's proprietor before making selection and purchase.

Due to the plurality of e-commerce sites selling similar products or services, online customers enjoy more choice and more control through making transactions online. The ease of use, in terms of locating price and product information, has become one of the crucial factors predicting online users' purchase decision. Further, another limiting factor of e-commerce systems is that they could only support one set of pricing rules for one or more specialized sets of goods or services.

An online customer visits an e-commerce site such as a travel agency site to find out more information on a product such as a travel package. However, an online customer may face two problems when making travel selections and purchases. Firstly, with reference to FIG. 1C, there may be difficulty in relating product information e.g. a travel package with the multimedia content presented at a travel agency's site. Secondly, with reference to FIG. 1B, the pricing information and its rules stated in a travel itinerary displayed on a travel agent's site are often confusing.

The first problem occurs as a site proprietor (e.g. a travel agent) may have to change their goods or services (e.g. travel package) published on a website on a frequent basis. These site proprietors are highly susceptible to commit data entry errors. This results in a mismatch between different modes of information. For example, as the result of an error, the entered description of a product does not match the entered multimedia content for the same product; a product describing Japan may have multimedia content reflecting landmarks in Egypt.

The second problem an e-commerce site proprietor of a travel business may face is the baffling price information published. For example, a travel agent charges a customer a price for an airline ticket based on the age of the traveller (e.g. infant, child & adult), flight type (e.g. local or international), promotional discounts (e.g. airline alliance or due to purchase of blocks of airline seats in advance) offered to the travel agent, type of seats (e.g. no frills, economy, business & first class) and type of airline (e.g. Qantas, SIA & the like). Similarly, travel agents charge customers hotel fees based on the type of hotel (e.g. Hyatt, Ritz Carlton & the like), type of rooms (e.g. Standard, Suite & the like), number of allowable persons in a room (e.g. 2 adults & 2 children) and promotional discounts (e.g. hotel affiliate programs & the like). These result in complex price tiers which are used in travel products. Often, online customers do not read or understand these rules associated with the price thus decide not to make the purchase resulting in potential loss of sales.

### SUMMARY OF THE INVENTION

An embodiment of the present invention provides an apparatus and method for a seller to publish goods or services and receive orders online. The seller provides the server computer with one or more products' descriptions which may comprise pricing data, text, photos, videos, and other multimedia content. The seller also provides the server computer with annotations which may comprise of text, photos, videos, and other multimedia content. These annotations can provide additional information on specific components in the product description such as specific words, phrases, multimedia objects, and other content. A product description may reference multiple annotations and an annotation may be referenced by multiple product descriptions. This referencing may be done automatically by the apparatus or may be manually effected by a publisher.

When a user requests for information regarding a product from the server computer via a computer, phone or other devices, via any operating system and browser, the server computer returns the product description. In addition to the product description, the server computer also creates and returns a multimedia presentation based on both the content in the product description and any referenced annotation. Additionally, the references between the content in the multimedia presentation to the content in the annotation to the content in the product description may be retained. This means that interaction with the multimedia presentation may include effects on both the product description and the annotation. Content in the annotation may be easily reused across multiple product descriptions and this significantly reduces data entry effort. Also, since content in the product description is automatically referenced to annotations, a multimedia presentation may be created with very little effort on the part of the publisher assuming the existence of relevant annotations. This may result in fewer mismatches between different modes of information and may reduce the occurrence of human error. A large amount of information may be better managed without overwhelming the proprietor or administrator. Time may be saved in not having to check for information mismatches. Also, this may result in a greater relevancy between information of different modes and may result in greater customer satisfaction.

Pricing information published in a goods or service description may comprise different pricing tiers and rules based on a customer profile. When a user requests, through software applications via a computer, phone or other devices, via any operating system and browser, for order placement from the server computer, the server computer examines the pricing data in the product description. Instead of revealing the pricing tiers and rules to the user, the server computer identifies key inputs that allow the server computer to automatically find the optimum pricing arrangements that meet the client's requirements based on a predetermined criterion. The identified pricing arrangement is then revealed to the user and the user may choose to make adjustments to the arrangements, the requirements, or the criterion or the combinations thereof used. As the user is not exposed to the complexity of the pricing information, the ordering process may be simplified and this may ensure that the user gets optimum arrangements without violating pricing rules. This method may allow e-commerce programs to support a wide range of pricing rules. Further, this may eliminate the need for a person to manually optimize travel arrangements based on the user's requirements. This may also result in travel arrangements which conform to the user's itinerary. This may also shield price variability and the complexity of pricing rules from the user, thus leading to a better user experience. Consequently, this may result in a more effective point of sale which may provide customers with content that is more accurate, and easier to understand.

### BRIEF DESCRIPTION OF THE DRAWINGS

For a better understanding of the present invention, reference may be made to the accompanying drawings, in which:

FIGS. 1A & 1B illustrate examples of how pricing information is conveyed to an online customer and FIG. 1B illustrates how the same online customer inputs their choice;

FIG. 1C illustrates an example of photos published on a site that may not depict the realistic expectations of the goods or services offered;

FIGS. 2A & 2B illustrate two examples of how an online customer inputs data when making travel arrangements;

FIGS. 3A & 3B illustrate two examples of different price rules and input requirements utilized by an Airline and Hotel respectively;

FIG. 4 is a data flow diagram of a routine to generate a multimedia presentation for a product description in accordance with an embodiment of the present invention;

FIG. 5 is a data flow diagram of a routine to enable ordering using required inputs in accordance with an embodiment of the present invention;

FIG. 6, consisting of 6A to 6D, illustrates examples of a database of annotations, a product description input, a product description with references to annotation using xml and an output of the multimedia presentation producer component using xml in the multimedia producer component, in accordance with an embodiment of the present invention;

FIG. 7, consisting of 7A-7C, illustrates examples of pricing information with six prices, a non-exhaustive list of pricing arrangements based on user's possible input and a possible definition of input requirement identification rules used in our pricing method in accordance with an embodiment of the present invention;

Also in FIG. 7, consisting of 7D-7F, illustrates an example of a user's input and the optimum pricing arrangement, in accordance with another embodiment of the present invention; and

FIG. 7G illustrates a pseudo code as an example of a possible criterion, minimum number of rooms, set by a publisher, in accordance with another embodiment of the present invention.

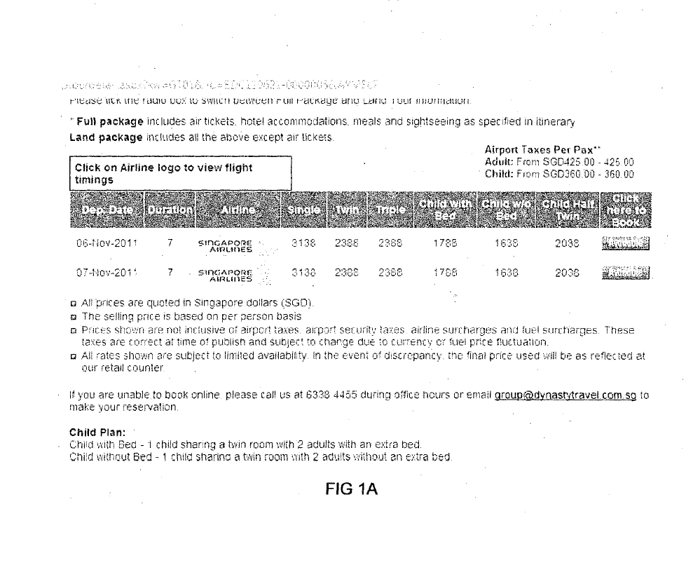

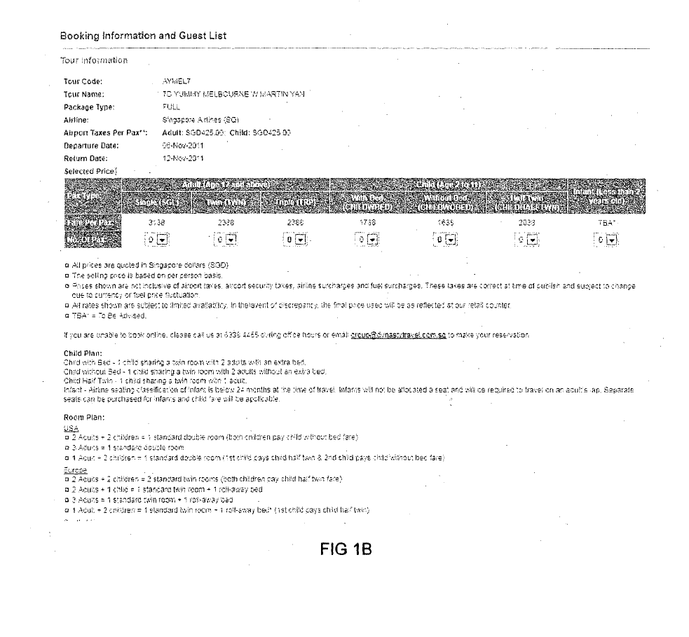

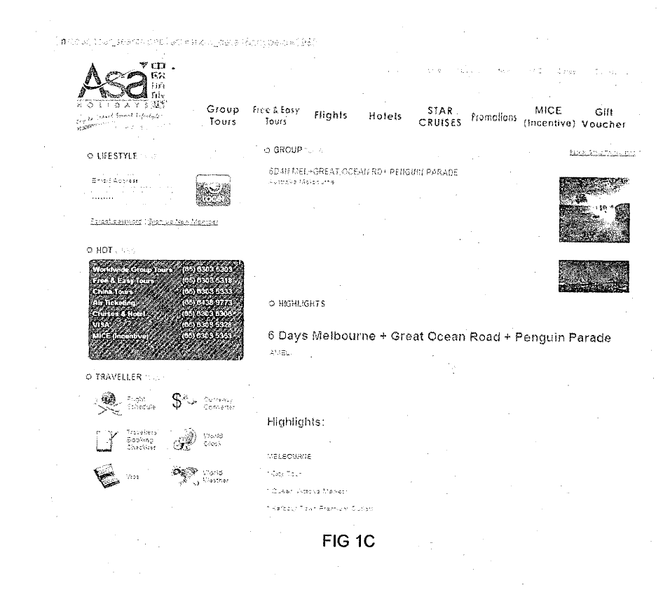

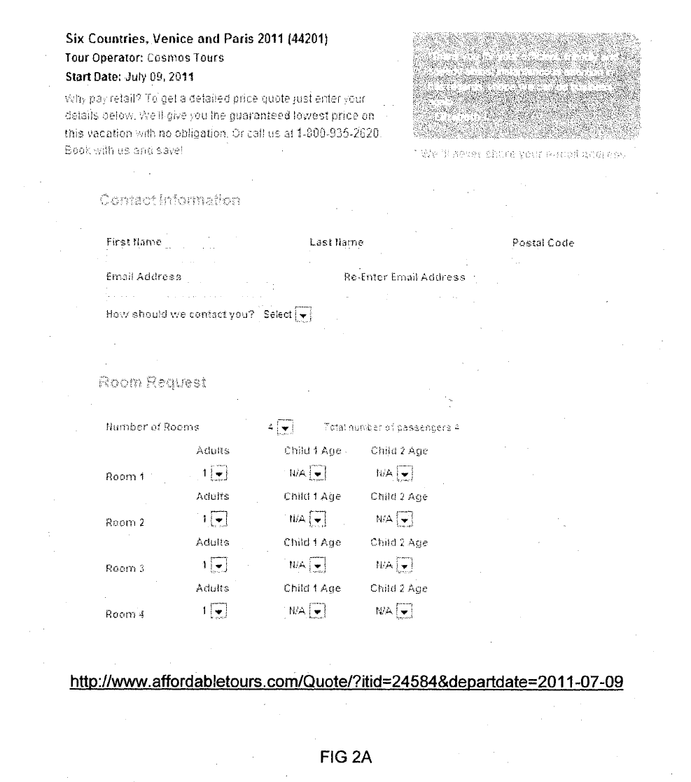

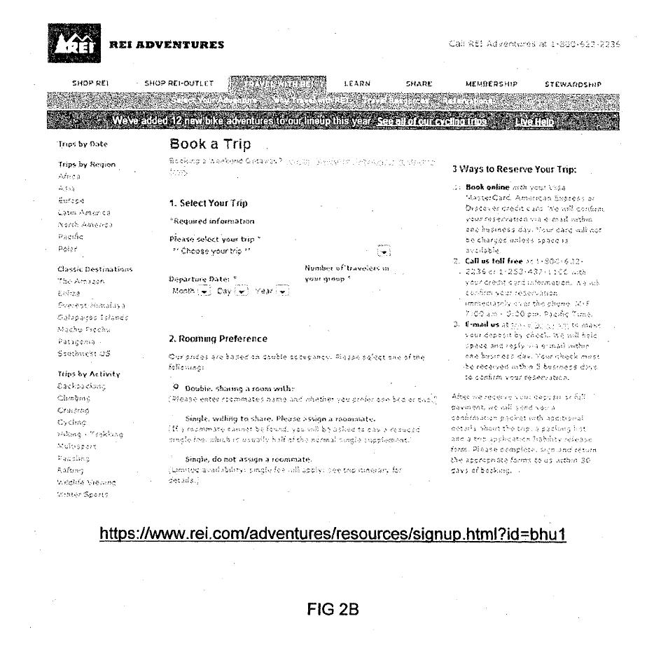

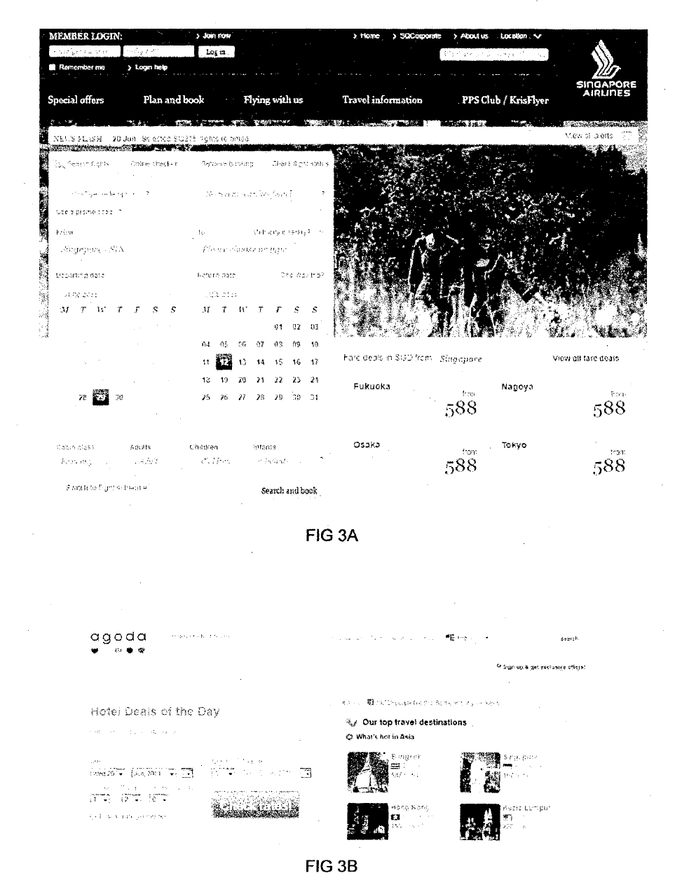

### DETAILED DESCRIPTION OF THE INVENTION

An apparatus and method for simplifying dynamic pricing information and multimedia referencing for e-commerce products may be used to publish items for sale from multiple vendors. The apparatus may involve a server, local networks, virtual private networks, or the Internet or any combinations thereof that stores a collection of data operable in e-commerce programs, which comprises pricing information, text, and other multimedia content managed via software applications through a user's computer, phone or other devices, and operating system and browser. The server computer also stores a collection of annotations consisting of text and other multimedia content. In an embodiment of the invention, content in a product description may be associated with annotations. The server computer may create a multimedia presentation based on the content in both the product description and the annotation associated with the contents in the product description. In another embodiment of the invention, the product description may also comprise of pricing data which consist of prices of at least one tier in which one or more rules are applicable. Instead of revealing the pricing tiers and rules to a user, the server computer may request to a user a set of required inputs that allow the server computer to automatically find the optimum pricing information, thus simplifying the purchase process.

The present invention provides an apparatus and method for publishing and receiving orders online. In one embodiment, the apparatus is used to publish information and receive orders on goods or services such as travel packages. The server computer contains a database of annotations which may comprise of text, photos, videos, and other multimedia content. The publisher provides the server computer with a description of one or more goods or services such as a travel itinerary which may comprise pricing data, text, photos, videos, and other multimedia content. The description is a text description that is entered into the server computer. In accordance with an embodiment of the invention, the reference identification component then examines the travel itinerary and automatically identifies keywords in the itinerary that references any annotations in its database. The publisher may also manually include additional references.

When a user requests, through software applications via a computer, phone or other devices, via any operating system and browser, for information regarding any goods or service such as a travel product, the multimedia presentation producer component examines the travel itinerary and records all references to annotations from the itinerary. For each reference to a annotation, the component records the photo and text description. This list of photos and text descriptions is returned to the user together with the travel itinerary. The list of photos and text may be presented in the format of a slideshow using a JavaScript library. While the above invention is described in terms of the JavaScript language the invention could also be implemented in any other language or languages that contain code that is processed and produces the output viewed by a web browser.

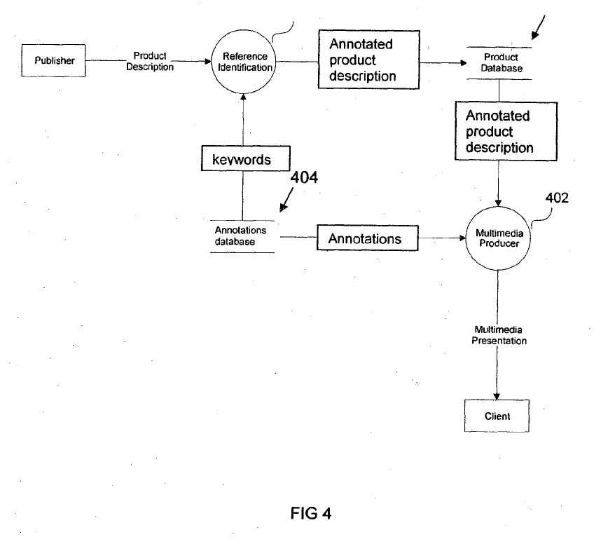

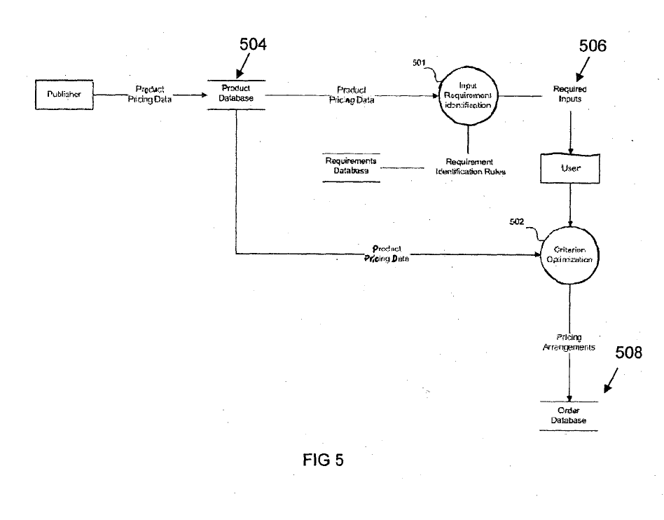

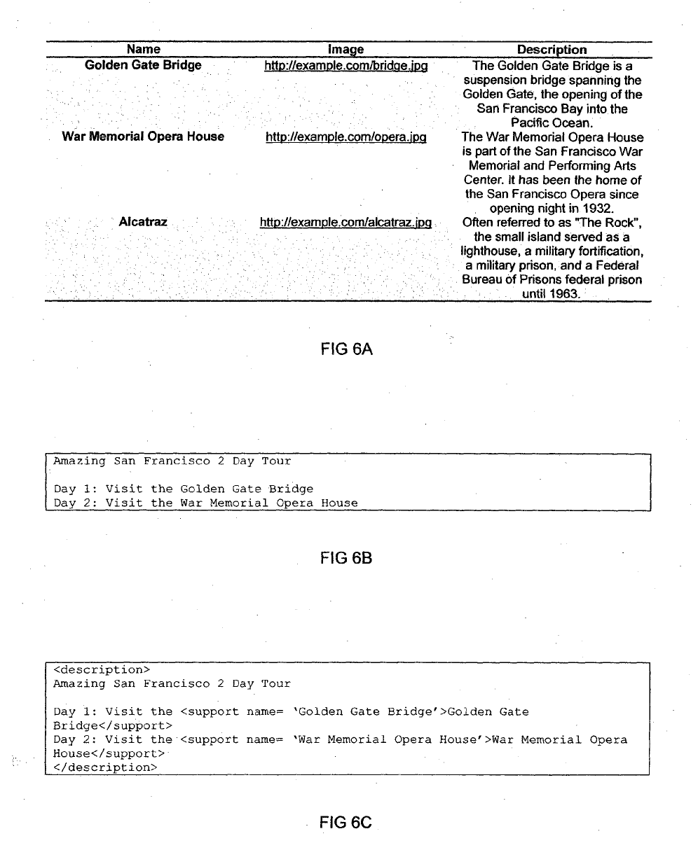

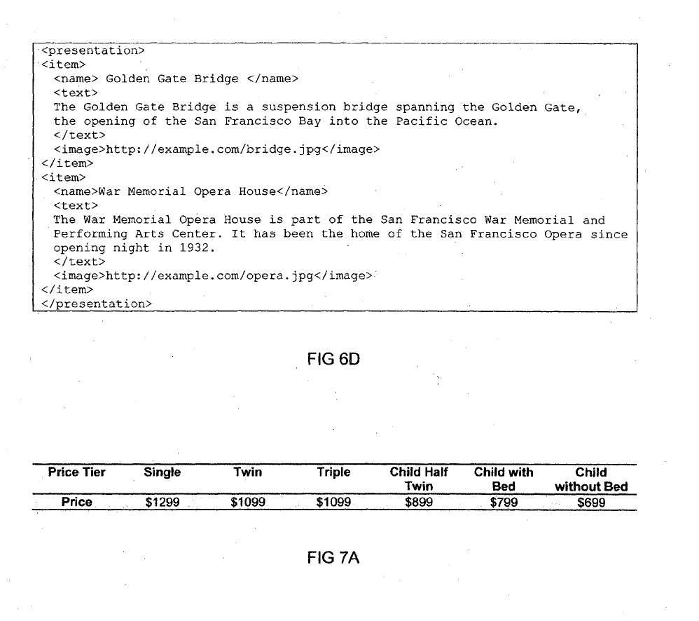

FIG. 6A-6D illustrate the data required to produce the multimedia presentation in one embodiment of the present invention. FIG. 4 is a diagram that illustrates the flow of data after the client computer requests for a multimedia presentation.

In 401, the reference identification component receives a product description (FIG. 6B) from the publisher. FIG. 6B shows a product description describing a travel product. The product description takes the form of plain text, but may be marked up with tags such as HyperText Markup Language (HTML) tags or Unicode special characters. The product description may be received via manual entry by the publisher via a web interface or through importing of files using known formats such as Microsoft Word Document, Adobe Portable Document Format, Rich Text Format, HTML, or any other supported formats. In the latter case, an extraction engine is used to extract the product description as text from the imported files.

In 404, a list of keywords is retrieved from the annotations database. It is noted that each keyword in the annotations database is associated with an annotation. The annotations are stored within the annotations database and each annotation may take the form of text, images, a HTML page and/or other multimedia content. For each keyword in the list, a string search using the keyword is done of the product description. Such a string search may use plain text matching, or may use matching with wildcards i.e. in the case where regular expressions matching is used. It is envisaged that the keyword may be a regular expressions string. Further, it is also envisaged that the annotations database may be constructed using web scrapping techniques e.g. Flickr, Wiki Media, Google Images and the like.

If a positive match is made, the string of the product description that matches the keyword is tagged. Such tagging marks up the matching string using a markup language such as Extensible Markup Language (XML) tags. Also, a web interface allows the publisher to manually tag words or phrases that are not automatically tagged. This allows alternate spellings to be tagged within the product description. This component then outputs a product description with references to one or more annotations i.e. an annotated product description (FIG. 6C). These references present in the annotated product description are also referred to as “supports”.

In 406, the annotated product description is then stored in the product database.

In 402, a client running on a computer requests for the multimedia presentation associated with a product. The Multimedia Producer component retrieves the annotated product description from the product database. The list of references (or “supports”) is then extracted from the annotated product description. The Multimedia Producer then queries the annotations database for the associated annotation of each reference. This produces a list of annotations (FIG. 6D). This list and the annotated product description is returned to the client.

At the client side, the list is incorporated into the annotated product description via browser native or non-browser native client-side technologies, for example, JavaScript and Adobe Systems Incorporated's Flash. This may be used to create an interactive multimedia presentation from the list of annotations. In the case where there are multiple references to the same annotation, the Multimedia Producer may filter out duplicate references, resulting in a more concise presentation.

In accordance with another embodiment of the invention, when a user requests, through software applications via a computer, phone or other devices, via any operating system and browser, for an order placement from the server computer, the server computer passes the pricing data through the input requirement identification component. To illustrate, a possible example of required inputs for a travel product order is “Number of Adult”, “Number of children who requires a separate bed”, “Number of children who do not require a separate bed.” The server computer then requests these inputs from a user. The user's input is then passed to the criterion optimizing component. In this embodiment, the criterion used is to minimize the number of rooms allocated. Consequently, the component would suggest to this user via a computer, phone or other devices, via any operating system and browser, a pricing arrangement that minimizes the number of rooms. If this user is not satisfied with the pricing arrangement, he may choose to input a new criterion (e.g. minimize price, allocate N number of rooms, hotel closest to location X or other criterion made available by the publisher), or choose to edit the pricing arrangements himself. After the user is satisfied with the pricing arrangement, he submits the order with the selected pricing arrangement. This order is received by the order management component.

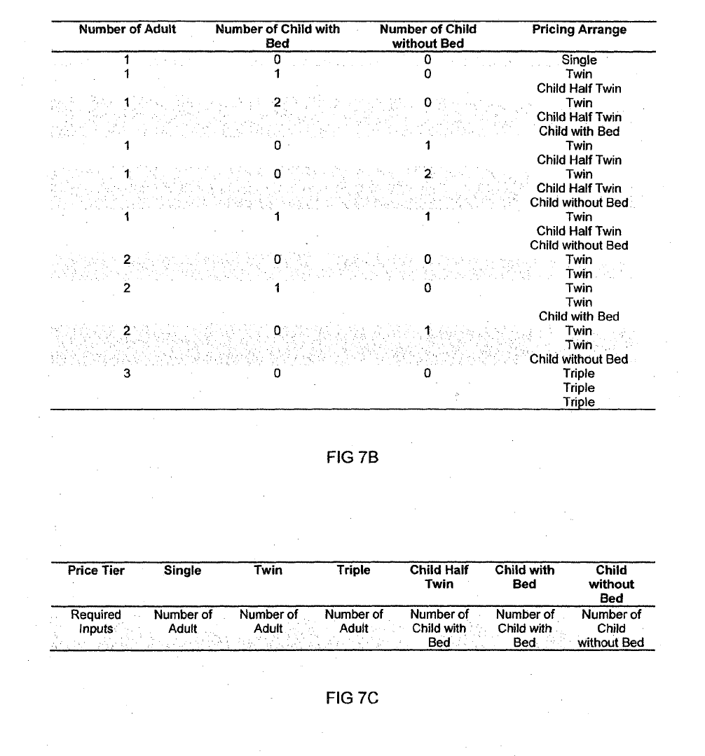

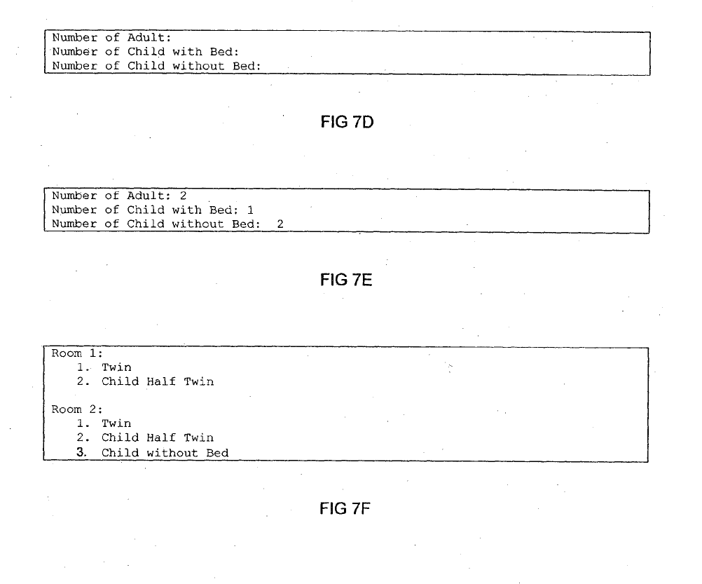

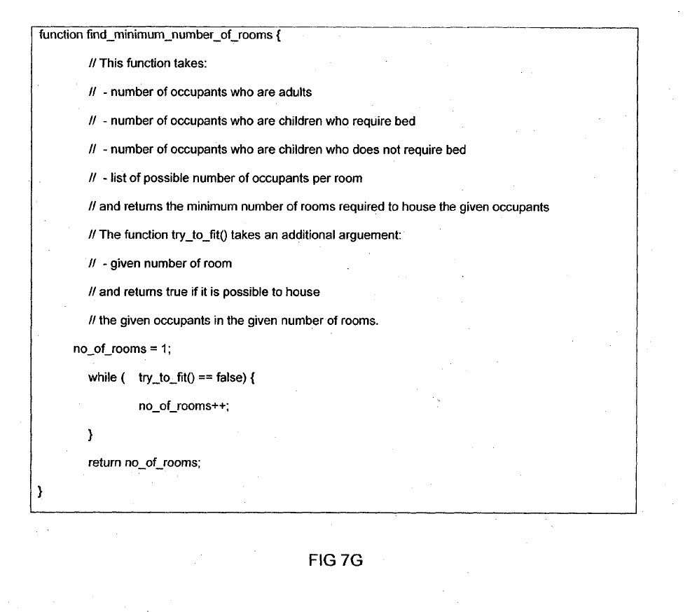

FIG. 7A-7F illustrates the data required to produce the required inputs and perform order placement in one embodiment of the present invention. FIG. 5 is a diagram that illustrates the flow of data from the time where the client initiates order placement till the time where the order is recorded in the database.

In 504, the publisher inputs the pricing data (FIGS. 7A & 7B) for his products and these data are recorded into the product database. The product pricing data also comprises a list of possible numbers of occupants for one or more type of rooms (e.g. Standard, Suite & the like) for one or more hotels (e.g. Hyatt, Ritz Carlton & the like).

In 501, a client running on a computer initiates the order placement process for a product. The product may for example be a tour involving an overnight stay. When this happens, an input requirement identification component running on the client retrieves the pricing data from the product database. Additionally, it retrieves the requirement identification rules (FIG. 7C) from the requirements database. FIG. 7C displays an example of a requirement identification rule where the requirements are found by looking up a table that lists the corresponding requirements (i.e. the lower row) for each price tier (i.e. the upper row).

In 506, the client is prompted for the inputs as shown in FIG. 7D. These inputs are parameters used in the ordering of the product, e.g. parameters indicating sleeping preferences such as the number of adults, children with bed and children without bed. A user may input these parameters into the client. Alternatively, these parameters may be stored with the client in the from of a persistent browser-based sessions file and be retrieved for use.

In 502, the parameters are processed by a Criterion Optimization component. The Criterion Optimization component may be client-side and run within the client. Alternatively, it may be server-side. The Criterion Optimization component minimizes the number of rooms based on the parameters provided by the client. The Criterion Optimization component may use the algorithm shown in FIG. 7G to compute the number of rooms required. The optimum pricing arrangement is derived using a lookup table stored within the product database. The Criterion Optimization component retrieves the lookup table from the product database. The input parameters to the lookup table are the number of adults, number of children with bed, and the number of children without bed i.e. the same parameters provided by the client or the user in Step 506. Using these parameters, the lookup table returns the associated pricing arrangement of a sleeping arrangement which requires a minimal number of rooms. This is done using information contained within the product pricing data entered by the publisher into the product database.

In 508, the pricing arrangement is displayed at the client. If a user of the client accepts the arrangement, the order is recorded in the order database.

In an example, Mr A has a family of two adults and a child who sleeps with the adults. In Step 506, Mr A inputs 02 for “Number of Adult” and 01 for “Number of children who do not require a separate bed”. Using the lookup table of FIG. 7B, in Step 502, the Criterion Optimization component returns a pricing that is a summation of “Twin”, “Twin” and “Child without Bed” pricing. This means that the child would be living in the same room as their parents without an extra bed.

In a further example, Mr A in Step 506 inputs 02 for “Number of Adult” and 01 for “Number of children who requires a separate bed”. Using the lookup table of FIG. 7B, in Step 502, the returned pricing may be a summation of “Twin”, “Twin” and “Child with Bed” pricing. This means that the child would be living in the same room as their parents with an additional bed.

In a further embodiment, the Criterion Optimization Component may proceed further by performing price comparisons before returning the pricing arrangement for display. Using the service tier indicated (e.g. where the user prefers a service tier of five stars), the Criterion Optimization Component obtains the pricing arrangements for all hotels recorded in a travel product that are of the indicated service tier. The Criterion Optimization Component then performs a comparison amongst the pricing arrangements to choose the hotel which offers lowest pricing arrangement.

In a yet further embodiment, the travel product may be a travel package and may thus comprise multiple product elements such as air fares, hotel stays, land tours. The Criterion Optimization Component accordingly obtains a lowest pricing arrangement for each product element. The Criterion Optimization component then returns the combination of product elements which yield the lowest overall pricing arrangement.

It is noted that the invention is not limited to the example embodiments described herein. Such embodiments are presented herein for illustrative purposes. Also, whilst example embodiments of the invention have been described in detail, many variations are possible within the scope of the invention as will be clear to a skilled reader.

1. A method of generating a presentation comprising:
providing input content consisting of a plurality of components, wherein a component can be marked as a reference
providing a database that contains a plurality of units of content, wherein a unit of content provides more information on a reference
providing a criterion for identifying a component of said input content as a reference
searching said input content for references according to said criterion, and extracting, from said database, units of content corresponding to the found references
generating a presentation using said extracted content by combining and organizing said extracted content together with said input content
whereby said presentation generated can contain more content than said input content
whereby a new presentation can be easily regenerated from new input content which contains a different composition of references, such that the generated presentation is always relevant to the input content

2. The method of statement 1 wherein said input content is a product description

3. The method of statement 2 wherein said product description is a travel itinerary

4. The method of statement 1 wherein said database is a collection of annotations comprising text, pictures, videos and other multimedia content

5. The method of statement 1 wherein said criterion is to find keywords in said input content that are relevant to units of content in said database.

6. The method of statement 5 wherein said criterion involves exact matching with plain text and wildcard matching for expressions.

7. The method of statement 1 wherein references can be added manually in addition to the references automatically identified by said searching

8. An apparatus for generating a presentation comprising:
providing a publisher that produces a product description
providing a server computer storing a database of annotations comprising of text and multimedia content
providing a reference identification component which searches said product description for keywords relevant to annotations in said database
providing a multimedia producer which combines said tagged product description with multimedia annotations in a single presentation
whereby said presentation generated can contain more content than said product description
whereby a new presentation can be easily regenerated from a new product description which contains a different composition of keywords, such that the generated presentation is always relevant to the product description

9. The apparatus of statement 8 wherein said multimedia producer can filter out duplicate annotations

10. A method of placing an order comprising:
presenting a plurality of items to a user of the client system for placing an order, whereby an item can have a plurality of pricing options
providing a means for receiving user inputs, which specify the general requirements of the user's order
providing a means for a merchant to set pricing rules that restrict the pricing options for an item according to said user inputs
providing a criterion for defining the best order, among the plurality of possible permutations, of said items in various said pricing options, limited by said user requirements
providing a method to optimize said order according to said criterion while conforming to said pricing rules
whereby said user is presented with said optimized order and is not shown excessive details of pricing options and is not able to submit an order that violates the pricing rules.

11. The method of statement 10 wherein the criterion is to minimize the total price of the order

12. The method of statement 10 wherein said items available for ordering are travel products

13. The method of statement 10 wherein said user inputs comprise of information necessary to determine travel arrangements

14. The method of statement 10 wherein said user inputs comprise of information necessary to determine airline ticketing arrangements

15. The method of statement 10 wherein said user inputs comprise of information necessary to determine hotel booking arrangements

16. The method of statement 10 wherein said user inputs comprise of the number of adults, the number of children who require a bed, and the number of children who do not require a bed

17. The method of statement 10 wherein said pricing options include original pricings and discounted pricings which are only available subject to said user inputs

18. The method of statement 10 wherein said pricing options include pricing tiers for single rooms and twin rooms in a hotel

19. An apparatus for placing an order comprising:
providing a product database with pricing data for items, wherein an item can have a few pricing tiers
providing an application for receiving user inputs relating to an order
providing a criterion optimizing component which uses an algorithm optimizes a user's order according to a given criterion and using pricing data from said product database
